(19) United States
(12) Patent Application Publication
(10) Pub. No.: US 2021/0380273 A1
(43) Pub. Date: Dec. 9, 2021

(54) PORTABLE AIRCRAFT SHELTER

(71) Applicant: Stephen Tillery, St. Louis, MO (US)

(72) Inventor: Stephen Tillery, St. Louis, MO (US)

(21) Appl. No.: 17/284,272

(22) PCT Filed: Oct. 11, 2019
(86) PCT No.: PCT/US2019/055922

§ 371 Date: Apr. 9, 2021

Related U.S. Application Data
(60) Provisional application No. 62/745,071, filed on Oct. 12, 2018.

(51) Int. Cl. B64F 1/00; E04H 15/22; E04H 6/44

(52) U.S. Cl. CPC B64F 1/005; E04H 6/44; E04H 15/22

(57) ABSTRACT

A portable shelter for an aircraft having an exterior contoured form includes a flexible enclosure configured to substantially enclose the aircraft within an interior of the flexible enclosure; an air maintenance unit in fluid communication with the interior of the flexible enclosure; wherein the air maintenance unit further comprises a blower and a temperature control unit in fluid communication with the blower; and wherein the air maintenance unit is configured to provide conditioned air to the interior of the flexible enclosure. An associated method for sheltering an aircraft is also disclosed.

### CROSS REFERENCE

This application claims the priority of, and expressly incorporates by reference herein the entire disclosure of, PCT Application No. PCT/US2019/055922, filed Oct. 11, 2019 which claims priority to U.S. Provisional Patent Application No. 62/745,071, filed Oct. 12, 2018, the entirety of both of which are hereby incorporation by reference.

### FIELD OF INVENTION

The present invention relates generally to aircraft maintenance and protection. More particularly, the present invention relates to portable aircraft shelter structure.

### BACKGROUND OF INVENTION

Aircraft, particularly smaller aircraft, are often left outside overnight at distant locations where indoor storage is not available or otherwise unfeasible and are exposed to extreme heat, cold, and/or inclement weather conditions. Extreme heat can cause damage to aircraft components by overheating them or cause seals to soften or melt. Extreme cold, on the other hand, can also cause problems. If ice or snow builds on certain areas of the aircraft, then the ice and snow can change the pattern of airflow over those surfaces which may cause longer takeoff rolls and a higher stall speed. In addition to degrading components and causing more dangerous flight conditions, extreme heat and cold can also cause the expansion and contraction of aircraft components. Those components must be checked and adjusted to compensate for those changes. The weather can also cause damage to the exterior of the aircraft, for example dents and more severe damage from hail or other severe storms.

Aircraft may be protected from extreme temperatures and weather conditions by parking the aircraft in an air quality maintained building. However, parking an aircraft in an air quality maintained building requires a large amount of space and high cost of utilities; thus, it can be cost-prohibitive, particularly to individual aircraft owners.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

According to one aspect of the present disclosure, there is provided a portable shelter for an aircraft having an exterior contoured form that includes a flexible enclosure configured to substantially enclose the aircraft within an interior of the flexible enclosure; an air maintenance unit in fluid communication with the interior of the flexible enclosure; wherein the air maintenance unit further comprises a blower and a temperature control unit in fluid communication with the blower; and wherein the air maintenance unit is configured to provide conditioned air to the interior of the flexible enclosure.

According to another aspect of the present disclosure, there is provided an associated method of sheltering an aircraft that includes the steps of providing a portable shelter that includes a flexible enclosure configured to substantially enclose the aircraft within an interior of the flexible enclosure; an air maintenance unit; wherein the air maintenance unit further comprises a blower and a temperature control unit in fluid communication with the blower; placing the flexible enclosure around the aircraft; closing the flexible enclosure around the aircraft; connecting the air maintenance unit with the interior of the flexible enclosure; and operating the temperature control unit to produce conditioned air and the blower to force the conditioned air into the interior of the flexible enclosure.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### DESCRIPTION OF THE DRAWINGS

Reference is now made more particularly to the drawings, which illustrate the best presently known mode of carrying out the invention and wherein similar reference characters indicate the same parts throughout the views.

FIG. 1 is a perspective view of an aircraft and an unassembled portable aircraft shelter according to a first embodiment of the present disclosure;

FIG. 2 is a perspective view of an aircraft and a partially assembled portable aircraft shelter according to an embodiment of the present disclosure;

FIG. 3 is a perspective view of an aircraft and an assembled portable aircraft shelter according to an embodiment of the present disclosure;

FIG. 4 is a perspective view of an aircraft and an assembled portable aircraft shelter according to an embodiment of the present disclosure;

FIG. 5 is a perspective view of an aircraft and an assembled portable aircraft shelter according to an embodiment of the present disclosure; and

FIG. 6 is a block diagram of an air quality maintenance unit without potential components that may be incorporated into various embodiments of a portable aircraft shelter according to an embodiment of the present disclosure.

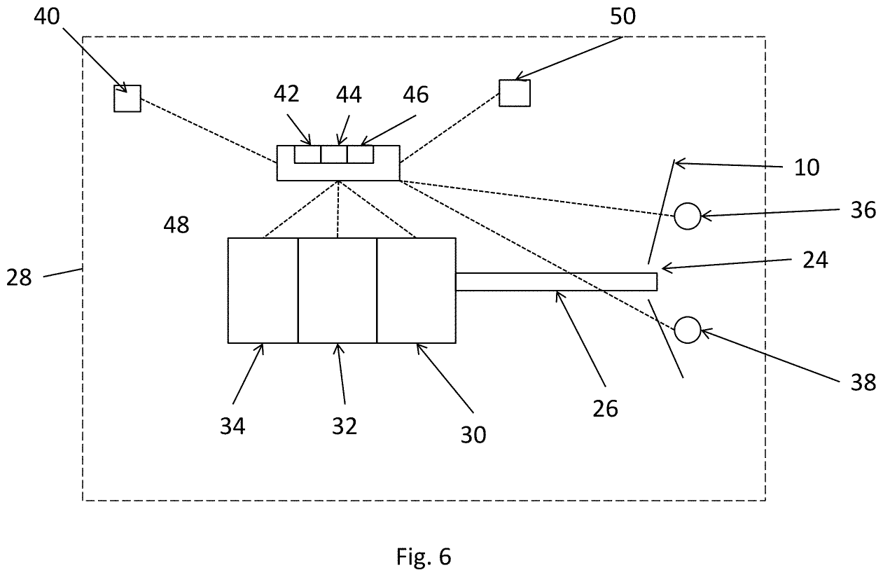

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention. The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

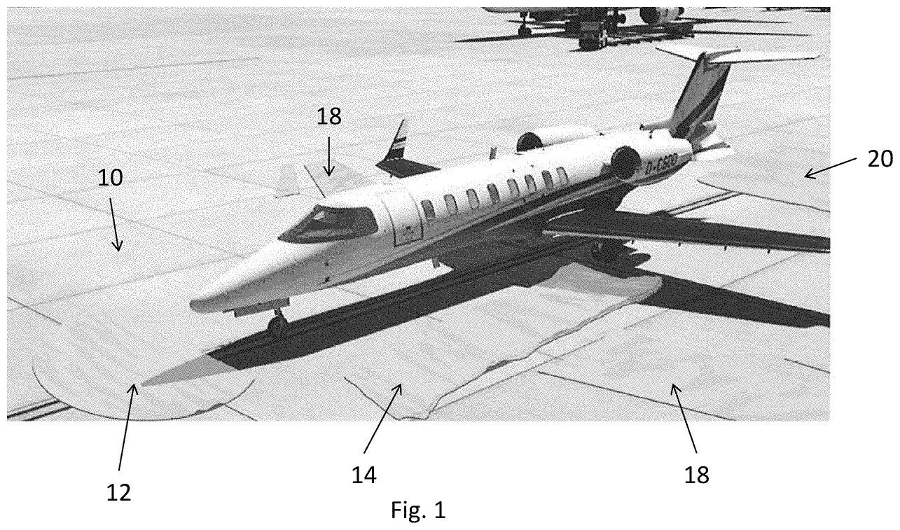

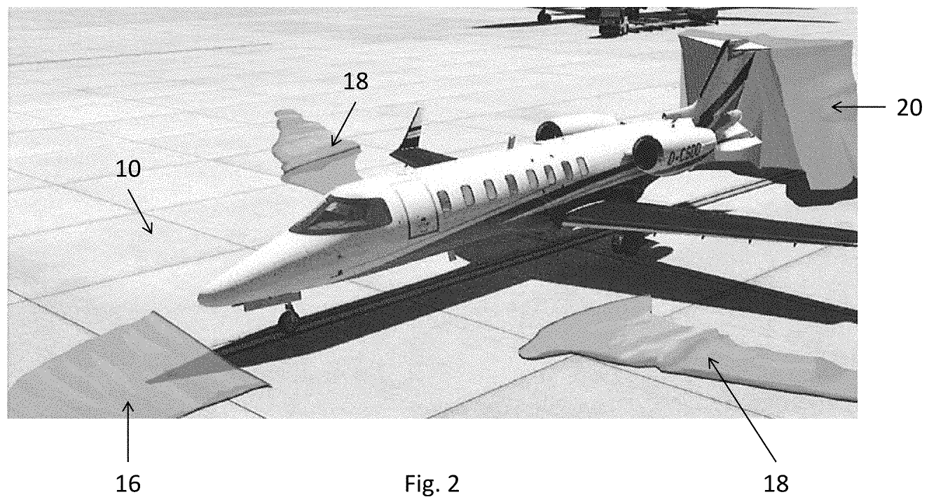

As shown in FIG. 1, in a first embodiment of a portable aircraft shelter 10, the aircraft shelter 10 may include a series of components that are able to selectively cover the entirety of an aircraft. As illustrated in the embodiment of FIG. 2, the series of components of the shelter 10 may include a cockpit component 12, a fuselage component 14, a first wing component 16, a second wing component 18, and a tail component 20.

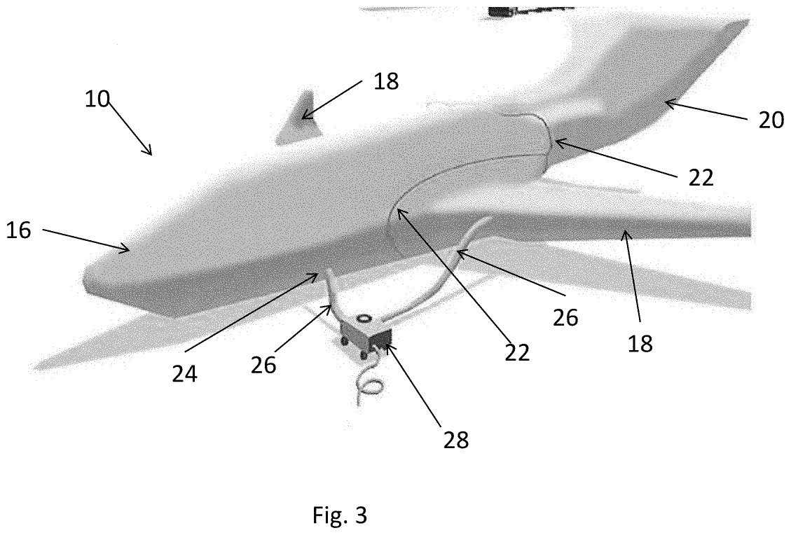

The cockpit component 12 may be advantageously size to accommodate the cockpit of the aircraft and is closed at one end and open at the other where it may meet the fuselage component 14. The cockpit component 12 preferably corresponds generally to the size and shape of the aircraft cockpit and has a roughly conical shape. In one embodiment illustrated in FIG. 3, the cockpit 12 and fuselage 14 (as described below in more detail) components may be formed as a unitary cockpit/fuselage component 16. This embodiment is preferred as it reduces the number of pieces that must be manipulated onto the aircraft and joined together to form the shelter 10.

The fuselage component 14 is arranged to cover the fuselage of the aircraft and, thus, will generally have an elongated, cylindrical shape. As noted above, the fuselage component 14 may be combined with the cockpit component 12 as a unitary component 16. Alternately, it may be provided as a separate component, as shown in FIG. 1. In either case, the aft end of the fuselage component 14 is preferably formed to slide around the wings of the aircraft. Further, the cockpit 12, fuselage 14, or unitary cockpit/fuselage components may be provided with openings to accommodate the wheel struts of the aircraft. In order to close the component behind the wheel struts, a selective securing mechanism, for example, a zipper, Velcro® fabric strips, magnetic closure, releaseable adhesive, or similar selective closure.

The system further includes two wing components 18 that correspond to the wings of the aircraft. The wing components 18 will generally be identical and suitable for use on either wing mirror simply flipping one wing component 18 over, thereby allowing the wing components 18 to be interchangeable. Alternately, the wing components 18 may be unique relative to one another in cases in which the wing configurations and/or dimensions of the aircraft of intended use differ in some respect. The wing components 18 are generally elongated and correspond to the shape of the wing of the aircraft. As with the cockpit component 12, the wing components 18 are closed at the wingtip ends and open at their respective fuselage ends. The specific shape of the wing components 18 may be dictated by the wing shape of the aircraft type with which they are intended to be used, which may vary. In embodiments intended for use with aircraft having winglets, the wing components 18 will preferably be arranged to accommodate the winglets or be separated into components sized for the winglets and the main portion of the wing.

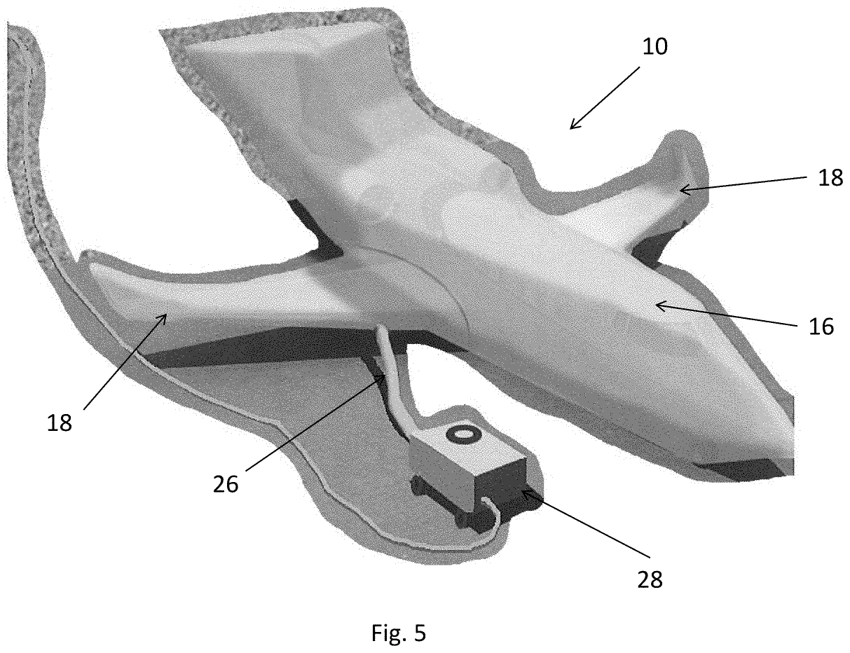

The system preferably also includes a tail component 20. As with the cockpit component, the tail component 20 is typically closed at its aft end and open at its fuselage end. The tail component 20 may extend to cover a portion of the aft end of the fuselage, thereby cooperating with the fuselage component 14. The tail section component 20 may further be arranged to accommodate the aircraft's engines as illustrate in FIGS. 3 and 5. In alternate embodiment, the tail section component 20 may be itself formed by separate sub-components arranged to correspond with the vertical and horizontal stabilizer portions of the tail section. The tail section component may also be integrated with the fuselage and cockpit components, as shown in FIG. 5. In another embodiment in which the tail section component 20 is arranged to be more form-fitting around the tail stabilizers, making it more difficult to slide a narrower section corresponding to the fuselage over the stabilizers, the tail component 20 may be provided with a securing mechanism, for example, a zipper, Velcro® fabric strips, magnetic closure, releaseable adhesive, or similar selective closure, to allow the opening of the tail section component 20 be enlarged for application and then closed to match the dimensions of the fuselage. Alternately, the tail section component 20 may be arranged in a larger, blocked form to more freely accommodate the stabilizers. In this embodiment, auxiliary straps may be utilized to tighten and pull the tail section component 20 toward the plane exterior surface subsequent to installation to reduce the space between the tail section component 20 and the plane surface. As will be understood by the description of other components of the shelter 10 below, such a reduction in intermediate space between the tail component 20 and the plane exterior surface may facilitate more efficient operation of the shelter system 10 by reducing the amount of space that must be heated or cooled. This same principal is applicable to the remaining shelter components.

In order to form the shelter 10, the various components described above may be mated together to generally enclose the aircraft. This mated relationship is illustrated more clearly in the embodiments shown in FIGS. 3 and 5. Once the various components 12-20 have been placed onto the aircraft, they may be pulled together to form a generally continuous enclosure around the aircraft. In order to ensure that the components stay in this enclosing relationship with one another, a selective securing mechanism is provided around the open end of each component. The securing mechanism 22 may be, for example, two sides of a zipper, a Ziploc® type-zipper arrangement, magnetic closures, releasable adhesives, or corresponding Velcro® fabric strips. The securing mechanisms between each pair of adjacent components may be thus be joined to maintain the adjacent components in the desired position for use of the shelter system 10 and subsequently to allow separation of the components to facilitate removal of the components from the aircraft.

The combination of the various components 12-20 with the securing mechanisms 24 between adjacent components generally provide for preventing moisture and/or foreign substances to migrate into the interior of the shelter 10 and, preferably, to reduce the flow of air into or out of the shelter 10. Therefore, in preferred embodiments, the flexible material used for each of the components may be generally impervious to moisture and air impermeable. Further, securing mechanisms that form a continuous seal between components are preferred. While producing completely air impermeable connectors is ideal, it is not necessary for the securing mechanism 22 or the component material to be completely air impermeable, as air losses from the interior of the shelter 10 may be compensated for with the flow rate of a blower 28 used in the system as described below.

The shelter system 10 further includes at least one aperture 24 that serves as part of the interface between the enclosure formed by the components 12-20 and the air quality maintenance unit 28 described below. The aperture 24 may be located and positioned anywhere on the shelter 10, including in any of the various components. However, as can be seen from the figures, it may be advantageous to position the aperture 24 at a lower point of the shelter 10 to facilitate connection of the aperture with the air quality maintenance unit 28.

A conduit 26 cooperates with the shelter aperture 24 to form a fluid connection between the interior of the component enclosure and the air quality maintenance unit. The conduit 26 is preferably flexible with a sufficient length to provide for at least some degree of adjustability in positioning of the air quality maintenance unit 28 relative to the aircraft. In some embodiment, the conduit 26 may be constructed from, for example, corrugated plastic or foil tubing. The conduit 26 may be preferable sized to facilitate a desired flow rate of air from the air quality maintenance unit 28 to the shelter interior without restricting that air flow.

The air quality maintenance unit 28 may include a number of primary components. These components include a blower 30 that is arranged to force feed exterior air into the interior of the shelter, preferably at a particular flow rate, through the conduit 26. As such, in various embodiments, the conduit 26 may be connected with an exhaust side of the blower 30. In a preferred embodiment, the flow rate that the blower 20 is capable of producing at least exceeds a leak rate associated with air escaping through the material of the components and the securing mechanisms. In a further preferred embodiment, the blower flow rate not only exceeds the leak rate but is also sufficient to substantially inflate the shelter 10 to create a buffer of air between the interior surface of the shelter components and the exterior surface of the aircraft. The resulting air buffer provides for a cushion providing a measure of protection for the aircraft, for example from hail, to avoid significant damage to the skin of the aircraft. The blower 30 may also be an air compressor, fan, or similar device that is capable of selectively moving air from one space to another.

The air quality maintenance unit 28 may further include a temperature control unit 32 in fluid communication with the blower 30. In one embodiment, the temperature control unit 32 is preferably connected with an intake side of the blower 30. Conditioned air from the temperature control unit 32 is supplied to the blower 30 and then flows through the conduit 26 and into the shelter interior to maintain a desired temperature within the shelter 10. With this arrangement, the temperature to which an aircraft is exposed may be moderated to minimize exposure to extreme heat or cold. The temperature control unit 32 may include a heater, an air conditioner, or both, which may be preferred in more temperate climates, or alternately only a heater or air conditioner in colder or warmer climates, respectively, depending on the ambient temperatures typically experienced in the relevant locations.

Each of the components of the air quality maintenance unit 28 may be powered by an A/C power connection of a suitable voltage from an available power supply at the landing/storage facility, a battery(ies) integral with the air maintenance unit 28 or positioned remotely, solar panels—again either integral with the unit 28 or remote, or other suitable power sources. Integrated power sources may be preferable in embodiments that are used in more remote locations where an outside power source may be unavailable or unreliable. Such integrated power sources may be less desirable for embodiments in use primarily at well-established facilities because those integrated power sources will generally add significant weight to the air quality maintenance unit, which must be accounted for and would typically increase fuel consumption during flight.

In another preferred embodiment, the air quality maintenance unit 28 may further include a thermostat 36, preferably positioned somewhere with the shelter interior space, to monitor the actual temperature within the shelter interior and adjust operation of the temperature control unit 32 to more consistently maintain a desired temperature.

In some embodiments, the air quality maintenance unit 28 may further include a humidifier/dehumidifier unit 34 in fluid communication with the temperature control unit 32 and blower 30 to control humidity levels within the shelter enclosure interior. The air quality maintenance unit 28 may also include a hygrometer 38 to measure humidity levels within the shelter enclosure. Use of a hygrometer 38 may be particularly useful in embodiments employing a humidifier/dehumidifier 34 to monitor operation of that unit and adjust operation of the unit accordingly to maintain a desired humidity level, which, again, may be fixed or set by the user.

The thermostat 36 and/or hygrometer 38 may communicate with the temperature control unit 32 via a wired or wireless, for example, by Bluetooth, near-field communication, or other wireless communication protocol, connection. This may be facilitated by the presence of a wireless communication unit in the air quality maintenance unit 28.

The air quality maintenance unit 28 may further include an alarm, which may be audible or visual in nature, for example, a horn, light, display, or similar device, to provide notice that temperature and/or humidity conditions within the shelter are outside of a desired range, which may be set by the user or fixed.

The air quality maintenance unit 28 may further include a cellular radio 44 connectable to a cellular network to allow for communication between the air maintenance device 28 and a remote communication device, for example, a cellular phone, tablet, computer, or other device. More particularly, the air maintenance device 28 may transmit a signal communicating current temperature and/or humidity levels within the shelter interior, operating condition(s) of the blower, temperature control unit, humidifier/dehumidifier, thermostat, and/or hygrometer, and/or any interruption in the power supply to the air quality maintenance unit 28. In the latter case, the air quality maintenance unit 28 may be provided with a backup battery 46 to allow for continued operation of at least the cellular radio 44 to allow for the operating condition signal to continue to be transmitted for at least some period of time and allow the aircraft owner, pilot, maintenance personnel to intervene.

To facilitate one or more of the foregoing electronic functions, a suitable processor 48 may be provided in the air quality maintenance unit 28. The processor 48 is preferably configured to communicate with the various components of the air quality maintenance unit 28 to receive signals from sensors, for example, the thermostat 36 and/or hygrometer 38, and adjust operation of the temperature control unit 32 and/or the humidifier/dehumidifier in accordance with temperature or humidity parameters that are user set or fixed within a memory associated with the processor 48. The air quality maintenance unit 28 may further include an input/output device 50, such as a keypad, keyboard, display, touchscreen, or similar device, to allow for interaction between a user and the processor 48 for the purpose of, for example, setting or adjusting operating parameters or displaying current conditions.

To facilitate further controls on operation of the air quality maintenance unit 28, exterior condition sensors 52, for example, an exterior thermostat and/or hygrometer, may also be incorporated into the system and connected with the processor 48 so that the processor can account for exterior conditions in adjusting operation of the temperature control unit 32 and/or humidifier/dehumidifier 34 to maintain the desired conditions with the shelter interior.

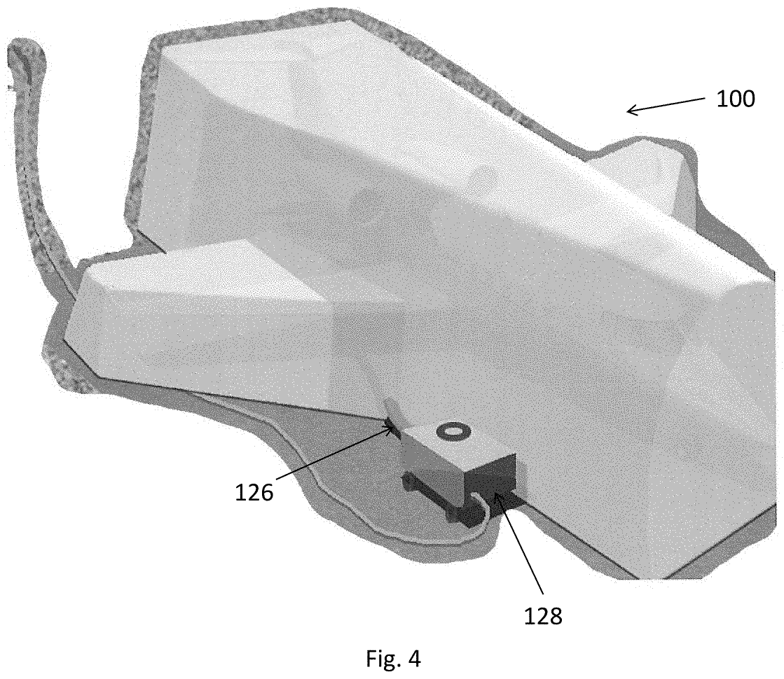

In a second embodiment of the shelter 100 as illustrated in FIG. 4, the shelter enclosure 100 may be formed by a single component. The single component 102 is arranged to fit over and roughly conform to the general contours of the aircraft. An open side of the component may be left open, preferably at least extending entirely to the ground around the aircraft, or be provided with one or more securing mechanisms to close the enclosure along the underside of the aircraft. This embodiment of the shelter 100 otherwise operates similarly to that of the first embodiment of the shelter 10 in that the interior of the shelter 100 is connected with an air quality maintenance unit 128 to affect air conditions within the shelter interior as described above.

The aircraft shelter enclosure components are preferably made from a lightweight fabric to facilitate installation, removal, and storage. This is particularly advantageous in that when the shelter is stored on board the aircraft, its lighter weight may reduce the amount of additional gasoline consumption. The lightweight fabric is further preferably waterproof or water resistant and substantially air impermeable. Thus, the aircraft shelter may protect the aircraft from rain, as well as minimizing exposure to extreme temperatures.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment but should be defined only in accordance with the following claims appended hereto and their equivalents.

What is claimed is:

1. A portable shelter for an aircraft having an exterior contoured form, comprising:
a flexible enclosure configured to substantially enclose the aircraft within an interior of the flexible enclosure;
an air maintenance unit in fluid communication with the interior of the flexible enclosure;
wherein the air maintenance unit further comprises a blower and a temperature control unit in fluid communication with the blower; and
wherein the air maintenance unit is configured to provide conditioned air to the interior of the flexible enclosure.

2. The portable shelter for an aircraft as set forth in claim 1, wherein the temperature control unit further comprises at least one of an air cooling unit, an air heating unit, or a combination thereof.

3. The portable shelter for an aircraft as set forth in claim 1, wherein the blower includes an intake and an exhaust and wherein the temperature control unit is connected with the intake of the blower.

4. The portable shelter for an aircraft as set forth in claim 1, wherein the flexible enclosure is formed from a substantially water resistant and substantially air impermeable material.

5. The portable shelter for an aircraft as set forth in claim 1, wherein the flexible enclosure comprises at least two enclosure components.

6. The portable shelter for an aircraft as set forth in claim 1, wherein the flexible enclosure comprises a single component.

7. The portable shelter for an aircraft as set forth in claim 5, further comprising at least one securing mechanism having first and second mating components and wherein the first mating component is connected to one of the at least two enclosure components and the second mating component is connected to the other of the at least two enclosure components, wherein the first and second mating components may be joined to selectively connect the at least two enclosure components with one another.

8. The portable shelter for an aircraft as set forth in claim 1, wherein the flexible enclosure comprises a single piece of material having a shape generally corresponding to an exterior form of the aircraft.

9. The portable shelter for an aircraft as set forth in claim 1, further comprising a loss flow rate associated with the flexible enclosure and wherein the blower is configured to produce a supply flow rate exceeding the loss flow rate of the flexible enclosure.

10. The portable shelter for an aircraft as set forth in claim 1, further comprising an air buffer between the flexible enclosure and an exterior surface of the aircraft during operation of the blower.

11. The portable shelter for an aircraft as set forth in claim 1, wherein the air maintenance unit further comprises a humidifier and/or a dehumidifier.

12. The portable shelter for an aircraft as set forth in claim 1, further comprising a thermostat positioned within the interior of the flexible enclosure and in communication with the temperature control unit.

13. The portable shelter for an aircraft as set forth in claim 11, further comprising a hygrometer positioned within the interior of the flexible enclosure and in communication with the humidifier and/or a dehumidifier.

14. A method for sheltering an aircraft, comprises the steps of:
providing a portable shelter, comprising:
a flexible enclosure configured to substantially enclose the aircraft within an interior of the flexible enclosure;
an air maintenance unit;
wherein the air maintenance unit further comprises a blower and a temperature control unit in fluid communication with the blower;
placing the flexible enclosure around the aircraft;
closing the flexible enclosure around the aircraft;
connecting the air maintenance unit with the interior of the flexible enclosure; and
operating the temperature control unit to produce conditioned air and the blower to force the conditioned air into the interior of the flexible enclosure.

15. The method for sheltering an aircraft as set forth in claim 14, wherein in the step of providing a flexible enclosure further comprises at least two components and at least one selective securing mechanism, and wherein the step of closing the flexible enclosure around the aircraft further comprises joining the at least two components with one another by closing the selective securing mechanism.

16. The method for sheltering an aircraft as set forth in claim 14, wherein the air maintenance device further comprises a humidifier and/or dehumidifier.

17. The method for sheltering an aircraft as set forth in claim 14, further comprising the steps of:
providing a thermostat;
setting a desired interior temperature within the interior of the flexible enclosure;
monitoring an actual interior temperature with the interior of the flexible enclosure; and
adjusting operation of the temperature control unit based on the measured actual interior temperature to return the actual interior temperature to approximately the desired interior temperature.

18. The method for sheltering an aircraft as set forth in claim 16, further comprising the steps of:
providing a hygrometer;
setting a desired interior humidity level within the interior of the flexible enclosure;
monitoring an actual interior humidity level with the interior of the flexible enclosure; and
adjusting operation of the humidifier or dehumidifier based on the measured actual interior humidity level to return the actual interior humidity level to approximately the desired interior humidity level.

19. The method for sheltering an aircraft as set forth in claim 14, further comprising the steps of:
providing a processor and a cellular communication device in communication within the air quality maintenance unit;
providing a thermostat configured to measure an actual interior temperature within the interior of the flexible enclosure;
determining with the thermostat and the processer the actual interior temperature within the interior of the flexible enclosure; and
transmitting from the cellular communication device the actual interior temperature to a remote communication device.

20. The method for sheltering an aircraft as set forth in claim 14, further comprising the steps of:
providing a processor and a cellular communication device in communication within the air quality maintenance unit;
providing a hygrometer configured to measure an actual interior humidity level within the interior of the flexible enclosure;
determining with the hygrometer and the processer the actual interior humidity level within the interior of the flexible enclosure; and
transmitting from the cellular communication device the actual interior humidity level to a remote communication device.
